(19) United States
(12) Patent Application Publication
(10) Pub. No.: US 2026/0333448 A1
(43) Pub. Date: Oct. 22, 2026

(54) CONFIGURATIONS FOR RANDOM ACCESS RESPONSE TIMER

(71) Applicant: Nokia Technologies Oy, Espoo (FI)

(72) Inventors: Samantha CAPORAL DEL BARRIO, Aalborg (DK); Smita SHETTY, Karnataka (IN); Tan YI, Cambridge (GB)

(21) Appl. No.: 19/116,668

(22) PCT Filed: Aug. 7, 2023
(86) PCT No.: PCT/EP2023/071794

§ 371 Date: Mar. 28, 2025

(30) Foreign Application Priority Data
Sep. 30, 2022 (IN) 202241056352

(51) Int. Cl. H04W 74/0833; H04W 74/00

(52) U.S. Cl. CPC H04W 74/0833; H04W 74/002

(57) ABSTRACT

Example embodiments of the present disclosure relate to beam correspondence. Terminal device obtains a first and a second configuration for a RAR timer during a RA procedure. The terminal device further applies the first configuration for the RAR timer for at least one RAR window during the RA procedure. The terminal device further applies the second configuration for the RAR timer for at least one other RAR window during the RA procedure, wherein the at least one other RAR window comprises at least a last RAR window of the RA procedure for a given SSB. In this way, the terminal device can hold its beam pattern and maintain the beam pattern for subsequent when the terminal device is in idle or inactive mode.

### FIELD

Example embodiments of the present disclosure generally relate to the field of telecommunication, and in particular, to devices, methods, apparatuses and a computer readable storage medium for configurations for random access response (RAR) timer.

### BACKGROUND

Beam correspondence (BC) requirements ensure that the downlink (DL) beam can be reused for uplink (UL), within a power threshold. BC requirements have currently only been defined in connected mode in 3GPP. There is a need to provide BC testing also for devices in idle or inactive mode.

### SUMMARY

In general, example embodiments of the present disclosure provide a solution for configurations for a RAR timer. Specifically, a solution for beam correspondence testing procedure for idle mode and inactive mode is provided.

In a first aspect, there is provided a terminal device. The terminal device may comprise one or more transceivers; and one or more processors communicatively coupled to the one or more transceivers, wherein the one or more processors are configured to cause the terminal device to: obtain a first configuration and a second configuration for a random access response, RAR, timer during a random access, RA, procedure; apply the first configuration for the RAR timer for at least one RAR window during the RA procedure; and apply the second configuration for the RAR timer for at least one other RAR window during the RA procedure, wherein the at least one other RAR window comprises at least a last RAR window of the RA procedure for a given synchronization signal block, SSB.

In a second aspect, there is provided a network device. The network device may comprise one or more transceivers; and one or more processors communicatively coupled to the one or more transceivers, wherein the one or more processors are configured to cause the network device to: determine a first configuration and a second configuration for a random access response, RAR, timer during a random access, RA, procedure, the first configuration being applicable for at least one RAR window during the RA procedure and the second configuration being applicable for at least one other RAR window during the RA procedure, the at least one other RAR window comprising at least a last RAR window of the RA procedure for a given synchronization signal block, SSB; and transmit the first configuration and the second configuration to a terminal device.

In a third aspect, there is provided a method at a terminal device. The method may comprise obtaining a first configuration and a second configuration for a random access response, RAR, timer during a random access, RA, procedure; applying the first configuration for the RAR timer for at least one RAR window during the RA procedure; and applying the second configuration for the RAR timer for at least one other RAR window during the RA procedure, wherein the at least one other RAR window comprises at least a last RAR window of the RA procedure for a given synchronization signal block, SSB.

In a fourth aspect, there is provided a method at a network device. The method may comprise determining a first configuration and a second configuration for a random access response, RAR, timer during a random access, RA, procedure, the first configuration being applicable for at least one RAR window during the RA procedure and the second configuration being applicable for at least one other RAR window during the RA procedure, the at least one other RAR window comprising at least a last RAR window of the RA procedure for a given synchronization signal block, SSB; and transmitting the first configuration and the second configuration to a terminal device.

In a fifth aspect, there is provided an apparatus. The apparatus may comprise: means for obtaining, at a terminal device, a first configuration and a second configuration for a random access response, RAR, timer during a random access, RA, procedure; means for applying, at the terminal device, the first configuration for the RAR timer for at least one RAR window during the RA procedure; and means for applying, at the terminal device, the second configuration for the RAR timer for at least one other RAR window during the RA procedure, wherein the at least one other RAR window comprises at least a last RAR window of the RA procedure for a given synchronization signal block, SSB.

In a sixth aspect, there is provided an apparatus. The apparatus may comprise: means for determining, at a network device, a first configuration and a second configuration for a random access response, RAR, timer during a random access, RA, procedure, the first configuration being applicable for at least one RAR window during the RA procedure and the second configuration being applicable for at least one other RAR window during the RA procedure, the at least one other RAR window comprising at least a last RAR window of the RA procedure for a given synchronization signal block, SSB; and means for transmitting the first configuration and the second configuration to a terminal device.

In a seventh aspect, there is provided a terminal device. The terminal device may comprise at least one processor; and at least one memory including computer program codes, wherein the at least one memory and the computer program codes are configured to, with the at least one processor, cause the terminal device to: obtain a first configuration and a second configuration for a random access response, RAR, timer during a random access, RA, procedure; apply the first configuration for the RAR timer for at least one RAR window during the RA procedure; and apply the second configuration for the RAR timer for at least one other RAR window during the RA procedure, wherein the at least one other RAR window comprises at least a last RAR window of the RA procedure for a given synchronization signal block, SSB.

In an eighth aspect, there is provided a network device. The network device may comprise at least one processor; and at least one memory including computer program codes, wherein the at least one memory and the computer program codes are configured to, with the at least one processor, cause the network device to: determine a first configuration and a second configuration for a random access response, RAR, timer during a random access, RA, procedure, the first configuration being applicable for at least one RAR window during the RA procedure and the second configuration being applicable for at least one other RAR window during the RA procedure, the at least one other RAR window comprising at least a last RAR window of the RA procedure for a given synchronization signal block, SSB; and transmit the first configuration and the second configuration to a terminal device.

In a ninth aspect, there is provided a non-transitory computer readable medium comprising program instructions for causing an apparatus to perform at least the method according to any one of the above third to fourth aspect.

In a tenth aspect, there is provided a computer program comprising instructions, which, when executed by an apparatus, cause the apparatus at least to: obtain, at a terminal device, a first configuration and a second configuration for a random access response, RAR, timer during a random access, RA, procedure; apply, at a terminal device, the first configuration for the RAR timer for at least one RAR window during the RA procedure; and apply, at a terminal device, the second configuration for the RAR timer for at least one other RAR window during the RA procedure, wherein the at least one other RAR window comprises at least a last RAR window of the RA procedure for a given synchronization signal block, SSB.

In a eleventh aspect, there is provided a computer program comprising instructions, which, when executed by an apparatus, cause the apparatus at least to: determine, at a network device, a first configuration and a second configuration for a random access response, RAR, timer during a random access, RA, procedure, the first configuration being applicable for at least one RAR window during the RA procedure and the second configuration being applicable for at least one other RAR window during the RA procedure, the at least one other RAR window comprising at least a last RAR window of the RA procedure for a given synchronization signal block, SSB; and transmit the first configuration and the second configuration to a terminal device.

In a twelfth aspect, there is provided a terminal device. The terminal device may comprise: obtaining circuitry configured to obtain a first configuration and a second configuration for a random access response, RAR, timer during a random access, RA, procedure; a first applying circuitry configured to apply the first configuration for the RAR timer for at least one RAR window during the RA procedure; and a second applying circuitry configured to apply the second configuration for the RAR timer for at least one other RAR window during the RA procedure, wherein the at least one other RAR window comprises at least a last RAR window of the RA procedure for a given synchronization signal block, SSB.

In a thirteenth aspect, there is provided a network device. The network device may comprise: determining circuitry configured to determine a first configuration and a second configuration for a random access response, RAR, timer during a random access, RA, procedure, the first configuration being applicable for at least one RAR window during the RA procedure and the second configuration being applicable for at least one other RAR window during the RA procedure, the at least one other RAR window comprising at least a last RAR window of the RA procedure for a given synchronization signal block, SSB; and transmitting circuitry configured to transmit the first configuration and the second configuration to a terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example network environment in which example embodiments of the present disclosure may be implemented;

FIG. 1B illustrates an example schematic view of 4-step RACH in accordance with some embodiments of the present disclosure;

FIG. 1C illustrates an example schematic view of 2-step RACH in accordance with some embodiments of the present disclosure;

FIG. 1D illustrates an example schematic view of RA procedure in accordance with some embodiments of the present disclosure;

FIG. 2 illustrates an example signaling process for beam correspondence in accordance with some embodiments of the present disclosure;

FIG. 3 illustrates an example flowchart of a method implemented at a terminal device in accordance with some example embodiments of the present disclosure;

FIG. 4 illustrates an example flowchart of a method implemented at a network device in accordance with some example embodiments of the present disclosure;

FIG. 5 illustrates an example block diagram of process for power ramping and RAR timer in accordance with some example embodiments of the present disclosure;

FIG. 6 illustrates an example flowchart of a method implemented at a terminal device in accordance with some example embodiments of the present disclosure;

FIG. 7 illustrates an example schematic view of selecting a panel in accordance with some example embodiments of the present disclosure;

FIG. 8 illustrates an example schematic view of beam refinement in accordance with some example embodiments of the present disclosure;

FIG. 9A illustrates an example block diagram of process for UE procedure for beam correspondence requirements in accordance with some example embodiments of the present disclosure;

FIG. 9B illustrates an example block diagram of process for UE procedure for beam tolerance in accordance with some example embodiments of the present disclosure;

FIG. 10 illustrates an example simplified block diagram of an apparatus that is suitable for implementing embodiments of the present disclosure; and

FIG. 11 illustrates an example block diagram of an example computer readable medium in accordance with some embodiments of the present disclosure;

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As used herein, the term “beam” may refer to a communication resource. Different beams may be considered as different resources. A beam may also be represented as a spatial filter. A technology for forming a beam may be a beamforming technology or another technology. The beamforming technology may be specifically a digital beamforming technology, analog beamforming technology, or a hybrid digital/analog beamforming technology. A communication device (including the terminal device and the network device) may communicate with another communication device through one or more beams. One beam may include one or more antenna ports and be configured for a data channel, a control channel, or the like. One or more antenna ports forming one beam may also be considered as an antenna port set. A beam may be configured with a set of resource, or a set of resource for measurement, and a beam may be represent by for example a reference signal and/or related resource for the reference signal. A beam may also represent by a reference cell identifier or resource identifier.

In millimeter wave (mmW) (e.g. FR2 and beyond), both gNB and UE have spatial filtering with antenna arraying, which increases the gain on each side though impacts reliability of the link when the beams are not aligned. Currently, FR2 is deployed with analog beamforming on the UE, i.e. single beam transmission at the time and spatial filtering of the Tx spherical coverage. Typically, a UE beam covers up to 90 degrees in the azimuthal plane per panel and can be refined to 22 degrees for a 1×4 linear array. Front-to-back antenna gain variation on UE may be up to 10-15 dB, i.e. not using the correct panel may result in the UE being unable to receive or transmit with the gNB.

In a third generation partnership project (3GPP) Release 16 (Rel-16), beam correspondence is introduced. BC requirements ensure that the DL gNB beam can be reused for UL within a power threshold. However, BC has been only defined in Rel-16 for connected mode, as well as Rel-17. In Release 18 (Rel-18), RAN4 requirements for BC for idle mode and inactive mode have been discussed. Rel-18 focuses on ensuring good random access channel (RACH) performance and UL coverage through UE beam correspondence requirements during radio resource control idle (RRC_IDLE) and radio resource control inactive (RRC_INACTIVE), possibly including small data transmission (SDT) during random access, which provide large potential for UE power saving opportunities and also improvements in latency and signaling overhead reduction. Therefore, BC tests may be needed also for UEs is RRC IDLE/INACTIVE modes.

In a random access (RA) procedure, after a UE sending a first message (e.g. preamble) transmission to a network, the UE waits for a response from the network. When there is no feedback with a random access response (RAR) window, a second message (e.g. the preamble) will be transmitted with higher power which is calculated as per some formulas (e.g. formulas of power ramping steps). This process continues till the UE either receives a response from the network or the maximum number of transmissions is exhausted. In case the maximum number of transmissions is exhausted, and the UE doesn't receive a response from the network, then a random access failure is declared.

In idle or inactive mode, a UE can only use synchronization signal block (SSB) reference signals for measurements. Currently nothing has been defined how frequently and accurately a UE needs to perform BC related measurements. Furthermore, a UE beamlock function is a test function defined in the specifications for frequency range 2 (FR2) UEs to lock the antenna pattern for subsequent tests. This has been defined so far only for the connected mode (or state), and there are not any specified radio access network 4 (RAN4) requirements for BC in inactive and idle ,p. Since now 3GPP will be defining BC requirements for IDLE and INACTIVE modes, the tests for the same also need to be defined. For meaningful measurements during tests, a UE needs to train its beam pattern in a particular direction for a long duration.

There are some problems in beam correspondence testing issues, such as how to enable UE to refine its beam in idle or inactive mode for BC requirements. Another example problem may be how to ensure that UE is maintaining the same refined beam during idle or inactive BC test when beamlock function is only active in connected mode.

Therefore, the present disclosure proposes a solution for a UE in the idle and inactive mode, such that the UE can hold its beam pattern for a sufficient length of time to carry out subsequent tests for BC.

Example embodiments of the present disclosure provide a mechanism to solve the above discussed issues, especially when to enable a sensor of a network device and which areas to be scanned by the sensor of the network device. The example embodiments of the present disclosure can improve resource utilization efficiency of sensing of the network device and also reduce impact on communication performance of the network device. Principles and some example embodiments of the present disclosure will be described in detail below with reference to the accompanying drawings.

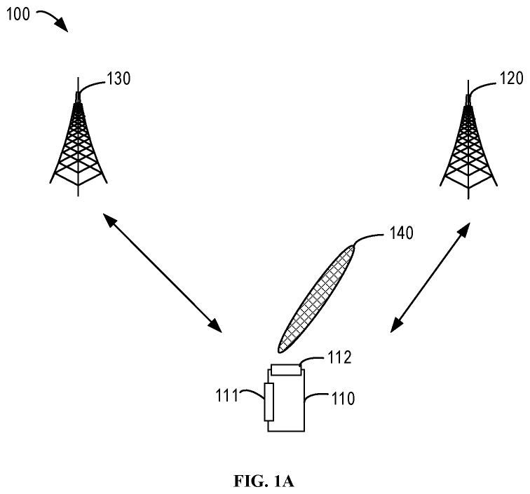

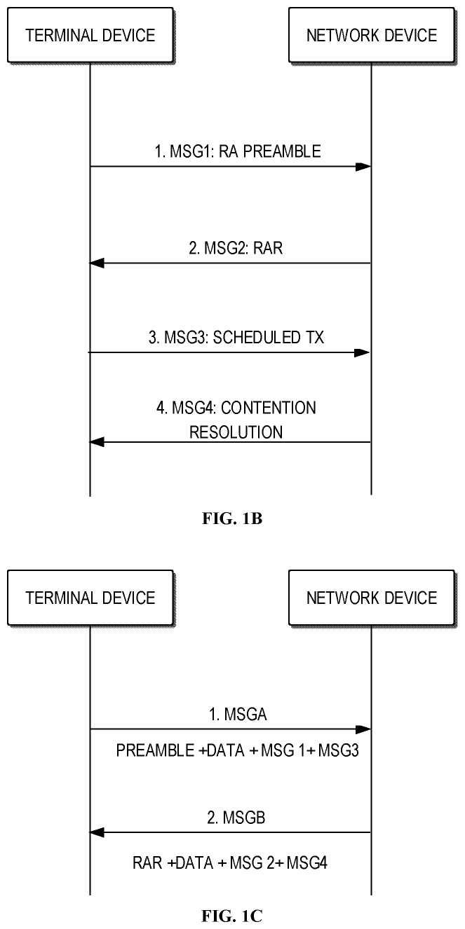

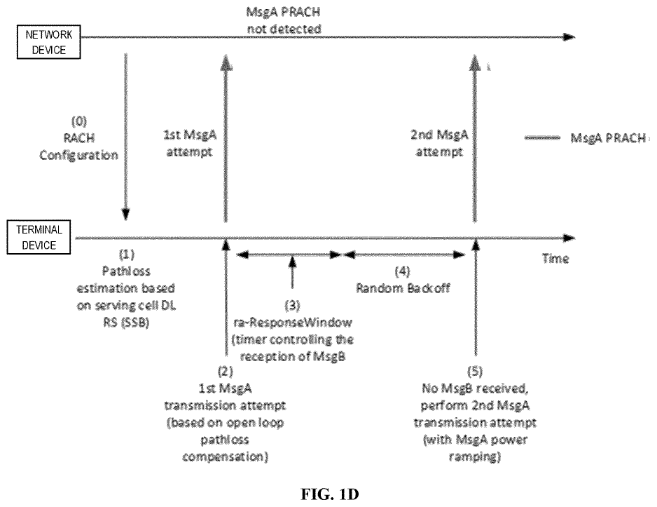

FIG. 1A illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one network device, and one terminal device that communicate with one another. It should be appreciated, however, that the description herein may be applicable to other types of apparatus or other similar apparatuses that are referenced using other terminology.

As illustrated in FIG. 1A, the communication network 100 may include a terminal device 110 (hereinafter may also be referred to as user equipment 110 or a UE 110). The communication network 100 may further include a network device 120 and a network device 130. Each network device of these network devices may manage one or more cells. As an example, a cell 140 may be managed by the network device 120. In addition, the network device 120 is configured with a plurality of beams which provides coverage for the cell 140.

The terminal device (e.g. UE 110) may have several panels, such as panel 111 and panel 112. Each panel may be corresponding to several beams. Beams could be refined (e.g. from a broad beam to a narrow beam) during RA procedure, and thus achieve the target transmission power.

Both network device 120 and UE 110 have spatial filtering with antenna arraying, which increases the gain on each side though impacts reliability of the link when the beams are not aligned. Currently, FR2 is deployed with analog beamforming on the UE, i.e. single beam transmission at the time and spatial filtering of the Tx spherical coverage.

Rel-16 and Rel-17 only defines beam correspondence and beamlock function for a UE in connected mode. However, for a UE in idle or inactive mode, the beam correspondence and the beamlock function are absent. Therefore, there is a need for providing a solution for a UE to hold the refined beam in idle or inactive mode.

It is to be understood that the number of network devices and terminal devices is given only for the purpose of illustration without suggesting any limitations. The system 100 may include any suitable number of network devices and/or terminal devices adapted for implementing embodiments of the present disclosure. Although not shown, it would be appreciated that one or more terminal devices may be located in the environment 100.

Reference is made to FIG. 1B and FIG. 1C. FIG. 1B illustrates an example schematic view of 4-step RACH in accordance with some embodiments of the present disclosure. FIG. 1C illustrates an example schematic view of 2-step RACH in accordance with some embodiments of the present disclosure.

It has defined two types of Random-access procedures i.e., 4 step RACH and 2 step RACH. The main motivation of introducing the 2 step RACH in Rel-16 is to reduce the overhead signaling and the latency (due to round trip time). A traditional 4 step RACH has 4 message exchange procedures between the UE 110 and the network device 120. The two step RACH as shown in the figure below combines:
message 1 and message 3 sent by the UE into a single msgA
message 2 and message 4 sent by the gNodeB into single msgB
   Msg A of the two step RACH has a higher payload due to the PUSCH being sent together with the preamble data.

In the RRC_INACTIVE and IDLE mode, UE 110 can perform Random access procedures. Random access procedures can be either a traditional 4 step RACH or a 2 step RACH depending on the UE capability and network configuration.

Reference is made to FIG. 1D, illustrates an example schematic view of RA procedure in accordance with some embodiments of the present disclosure.

For the Random Access procedure, there are certain parameters that the UE uses to determine the target power, i.e. the time to wait for a response from the network ra-ResponseWindow, the maximum number of retransmissions preambleTransMax, powerRampingStep and preambleReceivedTargetPower which is the target power as circled in red in the current RACH Configuration, in which:
preambleTransMax: Max number of RA preamble transmission performed before declaring a failure
ra-ResponseWindow: Msg2 (RAR) window length in number of slots.
powerRampingStep: Power ramping steps for PRACH
preambleReceivedTargetPower: The target power level at the network receiver side AUE 110 determines a transmission power for a physical random access channel (PRACH), as:

P_{PRACHb,f,c}(i)={P_{CMAXf,c}(i),P_{PRACHtargetf,c}+PL_{b,f,c}}
where P_{CMAX,f,c}(i) is UE's configured maximum output power defined in 3GPP standard specifications for carrier f of serving cell c within transmission occasion i, P_{PRACH, target,f,c} is the PRACH target reception power
PREAMBLE_RECEIVED_TARGET_POWER provided by higher layers [11, TS 38.321] for the active UL BWP b of carrier f of serving cell c, and PL_{b,f,c} is a pathloss for the active UL BWP b of carrier f based on the DL RS associated with the PRACH transmission on the active DL BWP of serving cell c and calculated by the UE in dB as referenceSignalPower—higher layer filtered RSRP in dBm, where RSRP and the higher layer filter configuration are defined in standard specs.

In real network deployments, PL is applied, but in the proposed beam correspondence test setup performed in controlled environment PL is omitted from the calculations.
The PRACH preamble power ramping is controlled by the MAC layer, which updates the P_{PRACH,target} according with the power ramping step (PREAMBLE_POWER_RAMPING_COUNTER), as follows:

P_{PRACH,target}(2)=PreambleReceivedTarget+DELTA_PREAMBLE+(PREAMBLE_POWER_RAMPING_COUNTER−1)×PREAMBLE_POWER_RAMPING_STEP
Where, PREAMBLE_POWER_RAMPING_COUNTER=2 for the 2nd PRACH transmission.

After sending the 1st Message transmission, UE 110 waits for a response from the network. When there is no feedback with the ra-Responsewindow, a 2nd message is transmitted with higher power which is calculated as per the formula stated above. This process continues till the UE either receives a response from the network or the maximum number of transmissions is exhausted. In case the maximum number of transmissions is exhausted, and UE doesn't receive a response from the network, then a random access failure is declared, or the UE may start again RA process on the same or another beam. gNB configures the max number of preambles the UE can transmit during the RACH process, if UE does not receive msg2 for the RACH preamble sent out, it waits for the random access response timer to expire and triggers RACH again. After ‘n’ number of tries if there is no response UE might declare RACH failure or start the RACH process gain. The UE may declare msg2 reception failure if it did not detect msg2 with RA-RNTI before the RAR timer expires.

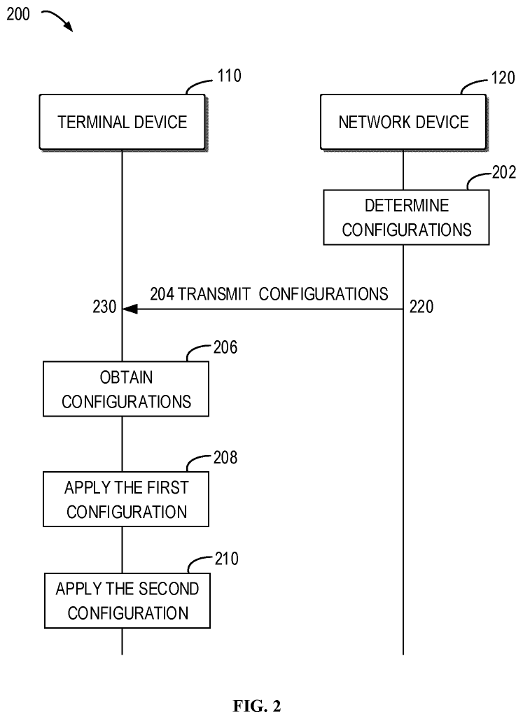

Reference is made to FIG. 2, which illustrates an example signaling process for beam correspondence in accordance with some embodiments of the present disclosure. In FIG. 2, UE 110 is taken as an example to illustrate the example process, however, it is just for illustrative purposes without limiting the present disclosure in any way.

At block 202, network device 120 determines a first configuration and a second configuration for a RAR timer during a RA procedure, the first configuration being applicable for at least one RAR window during the RA procedure and the second configuration being applicable for at least one other RAR window during the RA procedure, the at least one other RAR window comprising at least a last RAR window of the RA procedure for a given SSB.

In some example embodiments, the first configuration and the second configuration each may comprise a parameter indicating a time length of a RAR window. In some example embodiments, the second configuration may indicate a longer time length for the RAR window than the first configuration. In some example embodiments, the second configuration may be applicable only to the last RAR window of the RA procedure. In some example embodiments, the second configuration is not applicable to all RAR windows.

As an example, network device 120 determines the field of ra-ResponseWindow as the first configuration. Network device 120 determines the field of ra-ResponseWindow-test as the second configuration. One of an example configurations table is shown below in table 1 (where ra-ResponseWindow-test is in bold). All numerical values are examples.

TABLE 1

| Field | Value | Comment |
|---|---|---|
| prach-ConfigurationIndex | 190 | Preamble Format C2, with 10 ms PRACH |
| | | periodicity, and other detailed configuration |
| | | defined in table 6.3.3.2-4 in TS 38.211 [6]. |
| msg1-SubcarrierSpacing | Same as | |
| | UL carrier | |
| | SCS | |
| totalNumberOfRA-Preambles | 48 | Total number of preambles used for contention |
| | | based and contention free random access |
| numberOfRA- | 48 | No group B. |
| PreamblesGroupA | | |
| prach-RootSequenceIndex | 0 | Logic sequence index = 0, resulting in root |
| | | sequence = 1. |
| ssb-perRACH- | oneFourth, | OneFourth: 1 SSB associated with 4 RACH |
| OccasionAndCB- | n48 | occasions |
| PreamblesPerSSB | | n48: 48 contention based preambles per SSB |
| msg1-FDM | One | One PRACH transmission occasions FDMed in |
| | | one time instance. |
| rsrp-ThresholdSSB | RSRP_51 | The actual value of the threshold is −105 dBm, as |
| | | defined in TS 38.331 [2]. |
| ra-ContentionResolutionTimer | sf48 | 48 sub-frames |
| powerRampingStep | dB2 | |
| preambleReceivedTargetPower | dBm-120 | |
| preambleTransMax | n6 | Max number of RA preamble transmission |
| | | performed before declaring a failure is 6 |
| ra-ResponseWindow | sl10 | 10 slots |
| ra-ResponseWindow- test | S12560 | 12560 slots |
| zeroCorrelationZoneConfig | 11 | N-CS configuration, N_{CS} = 23 |
| Backoff Parameter Index | 2 | 20 ms, as defined in table 7.2-1 in TS 38.321 [7]. |

In an embodiment, the RAR timer configured with ra-ResponseWindow-test is only valid for the last preamble transmission. Keeping this RAR timer to a sufficiently large value will ensure that the UE keeps its beam while waiting for a RAR response from the network for a long period of time which will enable carrying out beam correspondence test or other tests in idle and inactive mode in the absence of the BEAMLOCK function. Therefore, extending the last RAR window (by using the second configuration) in idle/inactive state emulates the beamlock function of the connected state.

At block 204, the network device 120 transmits (220) the first configuration and the second configuration to a terminal device 110. On the other side of the transmission, the UE 110 receives (230) the first configuration and the second configuration.

At block 206, UE 110 obtains the first configuration and the second configuration for the RAR timer during the RA procedure. At block 208, UE 110 applies the first configuration for the RAR timer for at least one RAR window during the RA procedure. At block 210, UE 110 applies the second configuration for the RAR timer for at least one other RAR window during the RA procedure, wherein the at least one other RAR window comprises at least a last RAR window of the RA procedure for a given SSB. For example, the UE uses extended timer length for the last RAR window, based on the second configuration.

As an example, there is a certain number of preamble transmissions (up to preamleTransMax=N) and in between each of these transmissions, UE 110 has to wait for RAR during a RAR window. The first configuration is applied to N-1 transmitted preambles, and second configuration is applied to a last transmitted preamble. So instead of a RAR timer associated to a RAR window for the whole RA procedure, two RAR windows associated to different preamble transmission.

By means of such proposed solution as proposed herein, it is possible to enable the terminal device to hold its beam pattern and maintain the beam pattern for subsequent when the terminal device is in idle or inactive mode, while not slowing down each step of the RA procedure.

In some embodiments, UE 110 may hold, within the last RAR window, a beam pattern of the terminal device in a direction, wherein transmission power associated with the last RAR window is determined based on at least one power ramping step during the RA procedure. In some embodiments, the RA procedure may be carried out for the purpose of beam correspondence test. In some embodiments, UE 110 may maintain, within the last RAR window, the beam pattern for at least one subsequent test.

In some embodiments, the subsequent tests may be one or more of:
measure, within the last RAR window and with max ramped up power, one or more of:
   an effective isotropic radiated power (EIRP), and spherical coverage for UE conformance tests;
   an equivalent isotropic sensitivity (EIS) for DL; and
   an EIRP for UL.

In some embodiments, UE conformance tests may be Min peak EIRP, EIRP Spherical Coverage, EIS spherical Coverage, Refsens, beam correspondence tolerance.

In some embodiments, terminal device 110 may be further caused to follow a beam tolerance test comprising one or more of: transmit a last preamble before the last RAR window; transit from idle or inactive mode to a connected mode; and perform an uplink beam sweep.

In some embodiments, network device 120 may be further caused to perform at least one of: perform EIS Spherical Coverage test during last RAR window; perform EIRP test during the last transmitted preamble of RA; and perform EIRP spherical coverage test during the last transmitted preamble of RA.

In some embodiments, network device 120 may be further caused to perform: determine a first uplink power while the terminal device is in idle or in inactive mode, wherein the first uplink power is based on the last preamble sent by the terminal device before last RAR window timer is triggered; transition the terminal device into connected mode; determine a second received uplink power while the terminal device is in connected mode, wherein the second received uplink power is based on highest received power during the terminal device performs beam sweep in the connected mode; and perform beam tolerance test by comparing the first uplink power and the second uplink power. and the second uplink power.

In some embodiments, terminal device 120 may determine a first SSB parameter indicating a SSB periodicity, and apply the indicated SSB periodicity for performing alignment between a receive beam and a transmit beam. In some embodiments, terminal device 120 may determine a second SSB parameter indicating a number of SSBs per a synchronization signal burst, SS-burst, and apply the indicated number of SSBs for performing the alignment between the receive beam and the transmit beam. In some embodiments, the indicated number of SSBs per SS-burst is more than two, each SSB being associated with a dedicated index. In some embodiments, terminal device 120 may determine, based on the number of SSBs, a number of beams to be tested.

As an example, network device 120 determines the field of SSB periodicity and Number of SSBs per SS-burst. Network device 120 determines the fields of SS/PBCH block index and Symbol numbers containing SSBs. One of an example configurations table is shown below in table 2. All numerical values are examples.

TABLE 2

| SSB Parameters | Values | | | |
|---|---|---|---|---|
| Channel bandwidth | 100 MHz | | | |
| SSB SCS | 120 kHz | | | |
| SSB periodicity (T_{SSB}) | 5 ms | | | |
| Number of SSBs per SS-burst | 4 | | | |
| SS/PBCH block index | 0 | 1 | 2 | 3 |
| Symbol numbers | 4-7 | 8-11 | 4-7 | 8-11 |
| containing SSBs | | | | |
| Slot numbers containing SSB | 0 | 0 | 1 | 1 |

| | |
|---|---|
| SFN containing SSB | SFN mod (max(T_{SSB}, 10 ms)/10 |
| | ms) = 0 |
| RB numbers containing | (RB_{J}, RB_{J + 1}, . . . , RB_{J + 19}) |
| SSBs within channel BW | |

As far as what is known, SSB is the only reference signal available to a UE in inactive and idle state, thus it needs to introduce test based on SSB for beam correspondence for random access. The values stated in the table above are indicative and actual values and detailed test procedure needs to be decided in RAN4/5. In one example, SSB periodicity is set to 5 ms. In another example, SS/PBCH block index has four possible values, which is 0, 1, 2, and 3. In a further example, the number of SSBs per SS-burst is set to 4.

In some embodiments, UE 110 may determine the number of SSBs to determine a number of beams to be tested.

In some embodiments, UE 110 may obtain the second configuration by receiving, from a network device, a radio resource control, RRC, messages comprising the second configuration. In some embodiments, UE 110 may be in an idle mode or an inactive mode.

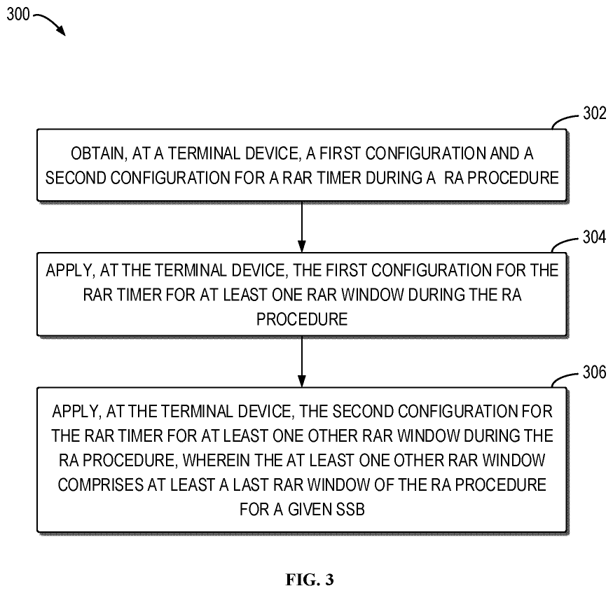

Reference is made to FIG. 3, which illustrates an example flowchart of a method 300 implemented at a terminal device in accordance with some example embodiments of the present disclosure. It is noted that method 300 can be performed in combination with or in addition to signaling flow 200. In method 300, a solution is provided for enabling beam correspondence at the terminal device.

At block 302, the terminal device obtains a first configuration and a second configuration for a RAR timer during a RA procedure. At block 304, the terminal device applies the first configuration for the RAR timer for at least one RAR window during the RA procedure. At block 306, the terminal device applies the second configuration for the RAR timer for at least one other RAR window during the RA procedure, wherein the at least one other RAR window comprises at least a last RAR window of the RA procedure for a given SSB.

Through method 300, the terminal device can hold its beam pattern and maintain the beam pattern for subsequent when the terminal device is in idle or inactive mode.

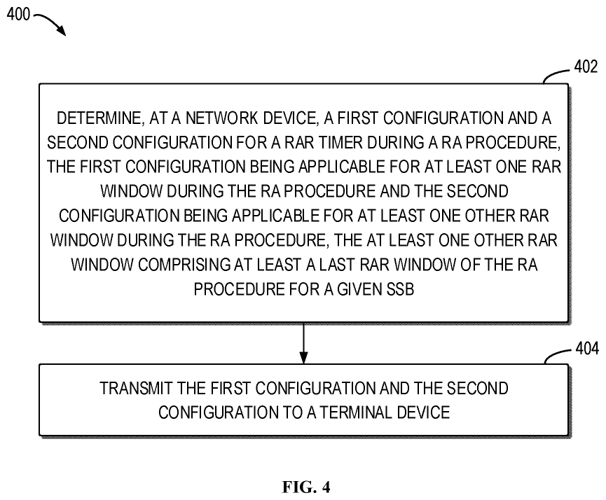

Reference is made to FIG. 4, which illustrates an example flowchart of a method 400 implemented at a network device in accordance with some example embodiments of the present disclosure. It is noted that method 400 can be performed in combination with or in addition to signaling flow 200. In method 400, a solution is provided for enabling beam correspondence at the network device.

At 402, the network device determines a first configuration and a second configuration for a RAR timer during a RA procedure, the first configuration being applicable for at least one RAR window during the RA procedure and the second configuration being applicable for at least one other RAR window during the RA procedure, the at least one other RAR window comprising at least a last RAR window of the RA procedure for a given SSB.

At 404, the network device transmits the first configuration and the second configuration to a terminal device.

Through method 400, the terminal device can be enabled to hold its beam pattern and maintain the beam pattern for subsequent when the terminal device is in idle or inactive mode.

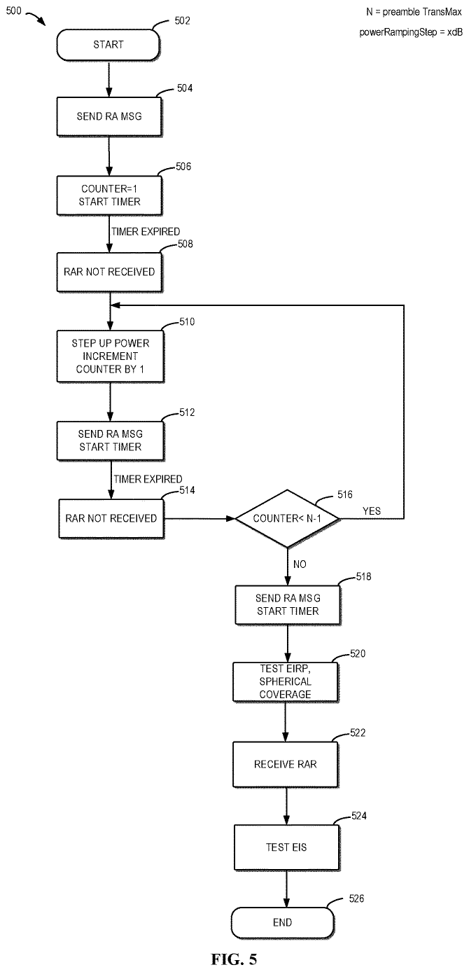

Reference is made to FIG. 5, which illustrates an example block diagram of process 500 for power ramping and RAR timer in accordance with some example embodiments of the present disclosure. The process 500 is illustrated with reference to FIG. 1A to FIG. 5. UE 110 is in inactive mode or idle mode during process 500.

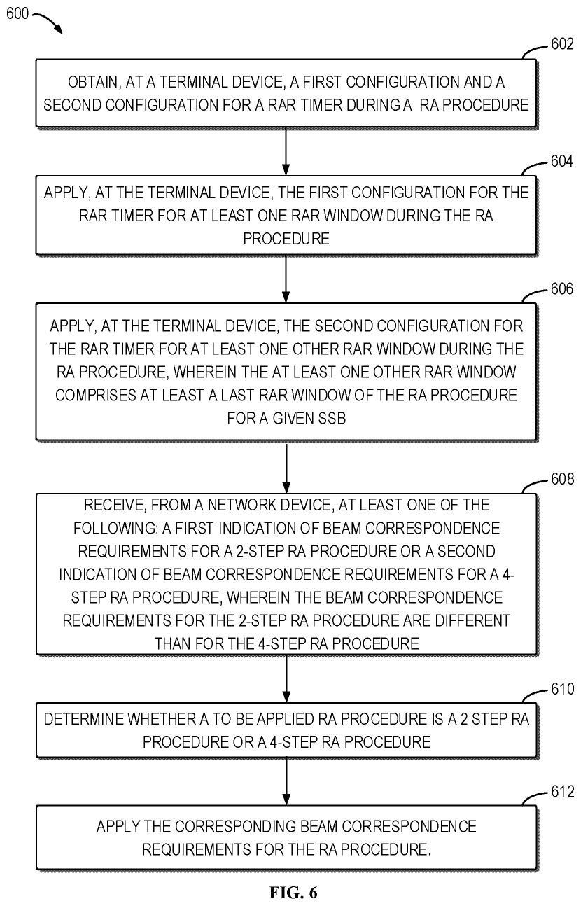

At 502, UE 110 starts a RA. At 504, UE 110 sends RA message. In one example, in case of a four-step RACH, UE 110 sends Message 1. In another example, in case of a two-step RACH, UE 110 sends Message A. In some embodiments, the present disclosure proposes a solution for beam correspondence requirements, which is described with FIG. 6 to FIG. 8 hereafter.

At 506, the PREAMBLE_POWER_RAMPING_COUNTER is set to 1. UE 110 starts a RAR timer. The length of the RAR timer is configured with ra-ResponseWindow. UE 110 waits until the RAR timer expires. At 508, it is determined that the UE has not received a RAR. At 510, the PREAMBLE_POWER_RAMPING_COUNTER is incremented by 1. At 512, UE 110 sends RA MSG again. UE 110 starts a RAR timer. The length of the RAR timer is still configured with ra-ResponseWindow. UE 110 waits until the RAR timer expires. At 514, it is determined that the UE still has not received a RAR. At 516, UE checks what is the counter value in relation to preamble TransMax number (referred as N). If the counter value is less than N−1, then the process 500 continues to 510. If the counter value is N−1, then the process continues to 518. At 518, UE 110 sends RA message again. UE 110 starts a RAR timer. The length of the RAR timer is configured with ra-ResponseWindow-test (i.e. based on the second configuration defining the ra-ResponseWindow-test). At 520, tests EIRP, spherical coverage. At 522, UE 110 receives RAR. At 524, UE 110 tests EIS. At 526, process 500 ends.

Through process 500, since the last RAR window can be configured with a sufficient large value, the terminal device can keeps its beam waiting for a RAR for a long period of time which will enable carrying out subsequent beam correspondence test or other tests as well in idle or inactive mode in the absence of the beamlock function.

Reference is now made to FIG. 6, which illustrates an example flowchart of a method implemented at a terminal device in accordance with some example embodiments of the present disclosure. Method 600 relates to the association between the random access type and beam correspondence requirement level.

In order for a UE to perform RA successfully in RRC_IDLE and RRC_INACTIVE, different beam correspondence requirements can be introduced depending on a RA type. The RAN4 requirements set the accuracy of the UE beam direction for each random access type. For example, there is a need for having tighter requirements for 2-step RACH vs 4-step RACH, since 2-step RACH has a higher payload, i.e. PUSCH in included in Msg A.

In another aspect, Small Data Transmission (SDT) is a procedure allowing data and/or signaling transmission while remaining in RRC_INACTIVE state (i.e. without transitioning to RRC_CONNECTED state). SDT is enabled on a radio bearer basis and is initiated by the UE only if less than a configured amount of UL data awaits transmission across all radio bearers for which SDT is enabled, the DL RSRP is above a configured threshold, and a valid SDT resource is available.

SDT can be used to send information to network on e.g. positioning. Specific examples of small and infrequent data traffic include the following use cases:
Smartphone applications:
   Traffic from Instant Messaging services
   Heart-beat/keep-alive traffic from IM/email clients and other apps
   Push notifications from various applications
Non-smartphone applications:
   Traffic from wearables (periodic positioning information, etc.)
   Sensors (Industrial Wireless Sensor Networks transmitting temperature, pressure readings periodically or in an event triggered manner, etc.)
   Smart meters and smart meter networks sending periodic meter readings

It is understood that block 602 corresponds to block 302. Block 604 corresponds to block 304. Block 606 corresponds to block 306. For a purpose of simplification, similar blocks are not elaborated.

At block 608, UE 110 receives, from a network device, at least one of the following: a first indication of beam correspondence requirements for a 2-step RA procedure or a second indication of beam correspondence requirements for a 4-step RA procedure, wherein the beam correspondence requirements for the 2-step RA procedure are different than for the 4-step RA procedure. At block 610, UE 110 determines whether a to be applied RA procedure is a 2 step RA procedure or a 4-step RA procedure. At block 612, UE 110 applies the corresponding beam correspondence requirements for the RA procedure.

For example, if the UE is to perform 2-step RA procedure, then the UE applies the BC requirements of the 2-step RA procedure during the RA procedure.

As one implementation example of FIG. 6, the UE receives all configurations for RA and for BC. Then, UE determines to apply the power control parameter, RAR window parameters/configurations, and which BC requirements to apply. Thereafter, the UE performs either 2-step RA or 4-step RA to meet the said BC requirements with either of 2-step RA or 4-step RA. That is, the order of steps in FIG. 6 may vary depending on implementation.

In some embodiments, the beam correspondence requirements for the 2-step RA procedure are more stringent than for the 4-step RA procedure, and wherein the requirements differ in at least one of the following: time required by the terminal device to measure downlink beam and to infer uplink beam, or uplink transmit power required for transmitting at least one RA message during the RA procedure.

As an example, since it is known that Message A of the two-step RACH has a higher payload due to the physical uplink shared channel (PUSCH) being sent together with the Preamble data. Thus, benefits of two-step RACH over four-step RACH include one or more of:
one round trip cycle between sending Msg A and receiving Msg B, instead of two round trip cycles between sending Msg 1 and receiving Msg 4;
reduced latency; and
reduces signaling overhead.

To achieve beam correspondence, when a UE has to perform RA in idle or RA in inactive mode for small data transmission (SDT), the following options can be performed:
option 1: relax the time taken by the UE to measure DL Rx beam and infer UL Tx beam.
option 2: increase the UE Tx power in UL to compensate for UL Tx UE beam misalignment.

Alternately, a combination of both option 1 and option 2 can be performed in either of the RACH procedures (i.e. 4-step or 2-step). The Rel-18 UE FR2 beam correspondence requirements for RACH on RRC_INACTIVE and RRC_IDLE may be defined based on the metrics (EIRP, spherical coverage) but with enhancements corresponding to different requirements for different types of RA procedures. The UE behavior is applicable for RACH for RRC_INACTIVE and RRC_IDLE. The embodiments thus introduce a new granularity in the BC requirements distinguishing between 2-step and 4-step RACH procedures for RRC_INACTIVE and RRC_IDLE.

In some embodiments, method 600 is applicable for different BC levels for one or more of the following use cases, or combinations of the following:
4-step RA for idle to connected
2-step RA for idle to connected
4-step RA in inactive for SDT
2-step RA in inactive for SDT
4-step RA from inactive to connected
2-step RA from inactive to connected

For the current Rel-18, since in IDLE and INACTIVE, SSB is the only means of measurement for the UE, SSB-based L1-RSRP measurement conditions will no longer be a side condition that will be applied based on certain criteria. Instead, these will be the main conditions to be fulfilled in INACTIVE and IDLE.

In some embodiments, method 600 proposes that relaxing the minimum SSB_RP (SSB reference point) for beam correspondence requirements by 6 dB in case of 4 step Random access in IDLE or INACTIVE mode, compared to CONNECTED mode. In some embodiment, the method 600 proposes to relax the minimum SSB_RP for beam correspondence requirements by 3 dB in case of 2 step Random access in IDLE or INACTIVE mode, compared to CONNECTED mode.

In some embodiments, table 3 shows an example configuration table for a 4-step RA to the specification with the example values below marked in bold. All numerical values are examples.

TABLE 3

| | | Minimum SSB_RP ^{Note 2} | SSB |
|---|---|---|---|
| Angle of | NR operating | dBm/SCS_{SSB} | Ês/Iot |
| arrival | bands | SCS_{SSB} = 120 kHz | dB |
| All angles | n257 | −90.2 | ≥6 |
| ^{Note 1} | n258 | −90.2 | |
| | n259 | −84.7 | |
| | n260 | −85.9 | |
| | n261 | −90.2 | |
| | n262 | −82.5 | |
| | n263 | TBD | |

^{Note 1}
For UEs that support multiple FR2 bands, the Minimum SSB_RP values for all angles are increased by ΔMBS, n, the UE multi-band relaxation factor in dB specified in clause 6.2.1.
^{Note 2}
Values specified at the radiated requirements reference point to give minimum SSB Ês/Iot, with no applied noise.

In some embodiments, table 4 shows an example configuration table for a 2-step RA to the specification with the tentative values below marked in bold. All numerical values are examples.

TABLE 4

| | | Minimum SSB_RP ^{Note 2} | SSB |
|---|---|---|---|
| Angle of | NR operating | dBm/SCS_{SSB} | Ês/Iot |
| arrival | bands | SCS_{SSB} = 120 kHz | dB |
| All angles | n257 | −93.2 | ≥6 |
| ^{Note 1} | n258 | −93.2 | |
| | n259 | −87.7 | |
| | n260 | −88.9 | |
| | n261 | −93.2 | |
| | n262 | −85.5 | |
| | n263 | TBD | |

^{Note 1}
For UEs that support multiple FR2 bands, the Minimum SSB_RP values for all angles are increased by ΔMBS, n, the UE multi-band relaxation factor in dB specified in clause 6.2.1.
^{Note 2}
Values specified at the radiated requirements reference point to give minimum SSB Ês/Iot, with no applied noise.

In scenarios of RRC_INACTIVE and RRC_IDLE, the beam correspondence tolerance cannot be based on the UL received power difference between the case where UE sweeps its Tx beams and the case where UE autonomously finds its best Tx beam since there is no UE Tx beam sweep in idle and inactive modes. Therefore, method 600 proposes a new beam correspondence tolerance definition, which is based on the difference between the peak EIRP in connected mode and in idle or inactive mode

In some embodiments, the beam correspondence tolerance requirement AEIRPBC INACTIVE for RRC_IDLE and RRC_INACTIVE for power class 3 UEs is defined based on a percentile of the distribution of ΔEIRP_{BC_INACTIVE}=EIRP₂−EIRP₁ over the link angles spanning a subset of the spherical coverage grid points, such that:
EIRP₁ is the total EIRP in dBm calculated based on the beam the UE chooses autonomously (corresponding beam) to transmit in the direction of the incoming DL signal, which is based on beam correspondence in idle or inactive modes and without relying on UL beam sweeping.
EIRP₂ is the total EIRP in dBm calculated based on the beam the UE chooses autonomously (corresponding beam) to transmit in the direction of the incoming DL signal, which is based on beam correspondence with relying on UL beam sweeping in connected mode.
The link angles are the ones corresponding to the top N^{th} percentile of the EIRP₂ measurement over the whole sphere, where the value of N is according to the test point of EIRP spherical coverage requirement for power class 3, i.e. N=50.

In some embodiments, for power class 3 UEs, the requirement is fulfilled if the UE's corresponding UL beams satisfy the maximum limit in the Table 5 and Table 6.

Table 5 is proposed for UE beam correspondence tolerance for PC3 for 4-step RA.

TABLE 5

| Operating | Max ΔEIRP_{BC}_{_{—}}_{INACTIVE} at 85^{th} %-tile |
|---|---|
| band | ΔEIRP_{BC}_{_{—}}_{INACTIVE} CDF (dB) |
| n257 | 6.0 |
| n258 | 6.0 |
| n259 | 6.2 |
| n260 | 6.2 |
| n261 | 6.0 |
| n262 | 6.2 |
| n263 | TBD |

NOTE:
The requirements in this table are verified only under normal temperature conditions as defined in Annex E.2.1

Table 6 is proposed for UE beam correspondence tolerance for PC3 for 2-step RA.

TABLE 6

| Operating | Max ΔEIRP_{BC}_{_{—}}_{INACTIVE} at 85^{th} %-tile |
|---|---|
| band | ΔEIRP_{BC}_{_{—}}_{INACTIVE} CDF (dB) |
| n257 | 3.0 |
| n258 | 3.0 |
| n259 | 3.2 |
| n260 | 3.2 |
| n261 | 3.0 |
| n262 | 3.2 |
| n263 | TBD |

NOTE:
The requirements in this table are verified only under normal temperature conditions as defined in Annex E.2.1

In some embodiments, the 2-step and 4-step Random access procedures from idle or inactive states are applicable for the following scenarios in FR2:In
4-step Random access for idle to connected mode transitions
2-step Random access for idle to connected mode transitions
4-step Random access in Inactive for Small Data transmissions
2-step Random access in Inactive for Small Data transmissions
4-step Random access for Inactive to connected mode transitions
2-step Random access for Inactive to connected mode transitions

In some embodiments, a finer granularity in the requirements, for example grouping the use cases listed above into the following 4 categories:
a. 2 step RA for SDT
b. 4 step RA for SDT
c. 2 step RA (for idle to connected and inactive to connected)
d. 4 step RA (for idle to connected and inactive to connected)

The above categorization of the requirements is listed from the group requiring the best beam correspondence (a.) to the one accepting the largest relaxation (d.). This proposed prioritization is based on the consequence of failing UL transmission in each of those categories. Namely a. 2-step RA for SDT is used e.g. to send positioning data of the UE where the payload is sent together with the preamble in Msg A. Then, the UE goes back to inactive. Hence, missing the Msg A means not receiving the corresponding data. Thus, justifying stricter requirements for this case. Therefore, the BC requirements are tighter for RA procedures carrying SDT than for RA procedures without SDT. This SDT related requirement may overrule or be combined with the embodiment where BC requirements are tighter for 2-step RA procedures than for 4-step RA procedures.

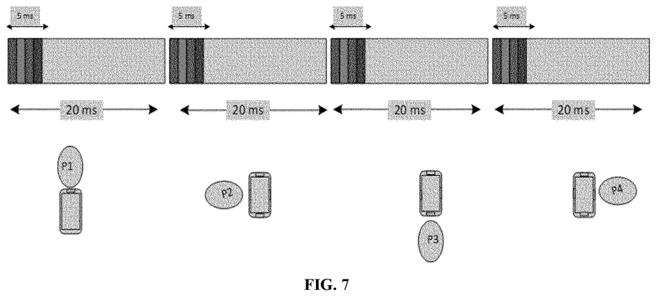

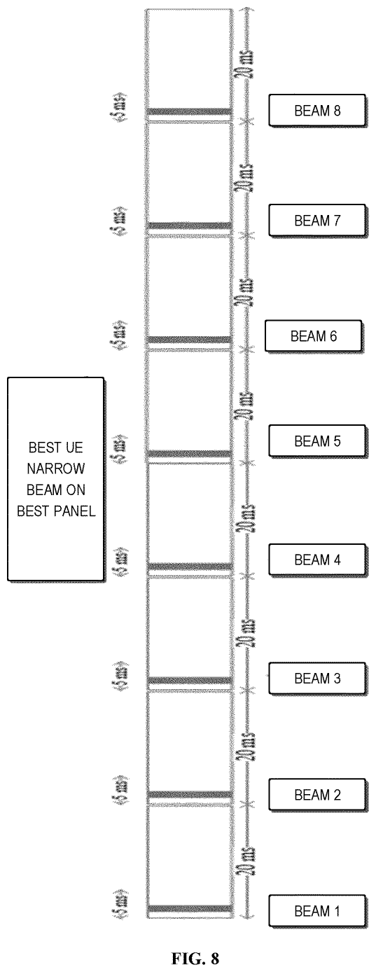

FIG. 7 illustrates an example schematic view of selecting a panel in accordance with some example embodiments of the present disclosure. FIG. 8 illustrates an example schematic view of beam refinement in accordance with some example embodiments of the present disclosure. FIG. 7 and FIG. 8 is combined to describe the processes that a ULE can perform to meet the beam correspondence requirements.

In some embodiments, While SS bursts can have a different periodicity (e.g. 5 ms, as explained above), a default periodicity of 20 ms is used in this example for illustration purposes. In some embodiments, a UE can meet the beam correspondence requirements in one of the following ways:
1. Use the gyroscope to estimate the rotation of the UE during the sleep period and estimate the correct panel to use when waking up.
2. Have a UE RF architecture including splitters to all panels to be able to send. simultaneously on all panels to ensure that the correct direction is also covered.
3. Monitoring SS burst on all panels during the sleep period.

In some embodiments, regarding the above option 3, there is provided some details on UE behaviour. As a baseline, there may be three steps the UE can perform. Though RRC_IDLE and RRC_INACTIVE are essentially power saving states, in order to ensure accurate beam correspondence, the UE may need to perform measurements regularly, or at least before the next scheduled UL.
Step 1. As shown in FIG. 7, UE 110 measures the SS burst on each of its panel and decides the best panel based on the L1 RSRP measurement. The UE best panel may be the one that receives the highest RSRP value among all SSBs of the SS burst.
Step 2. As shown in FIG. 8, assuming UE 110 figures out that P1 may be its best panel based on L1 RSRP measurements, it then uses this panel to sweep the narrow beams of this panel only thereby doing a beam refinement.
Step 3. The UE decides the best serving SSB beam from Step 2 based on L1 RSRP measurements. Assume the RSRP measurement is equal to a first value RSRP_1. UE keeps periodically measuring on this narrow beam as long as the RSRP is equal to RSRP_1. When it finds there is a change in the RSRP measurement above a threshold, the UE first measures with the broad beam on the same panel. If the broad beam measurement is unchanged (+/−1 dB) then the UE knows that the same panel is still the best one, only the narrow beam of the panel needs to be adjusted. And then checks the narrow beam.ie performs step 2 again. Otherwise, if the broad beam measurement has varied significantly, the UE infers that the panel itself is not aligned anymore. It will then skip all narrow beams of this panel and find another panel among the remaining ones with best RSRP value (step 1), then select the narrow beam of this panel (step 2). Note that for a 1×4 array there is typically 6 dB gain difference between broad and narrow beams. This difference becomes larger with larger arrays (+3 dB every time the number of elements of the array doubles).

The above method 600 is aim to find beam correspondence with a narrow beam at the UE, which can add latency since the UE needs to measure sequentially on all its panels and then on all the narrow beams of at least one panel. There can be two scenarios based on latency requirements, available power headroom and mobility of the UE.
scenario 1: UE has enough time to align its panels and beams (e.g. enough measurement time with SSB periodicity before SDT transmission) and UE is power limited (e.g. cell edge UE), then the UE chooses tp prioritize beam accuracy to fulfil beam correspondence requirements.
scenario 2: UE does not have enough time to align its panels and beams and has enough power headroom to compensate for misalignment (e.g. UE close to gNB), then the UE chooses to skip the beam refinement (step2) and compensate for it with transmitting a higher power.

The amount of power needed to transmit with depends on whether UE uses 2-step or 4-step RA since the 2-step RA includes the payload in MsgA. When the number of PRBs is doubled, UE needs to transmit with 3 dB more power to maintain spectral efficiency.

Through method 600, it has power save implications for the UE and it is a trade-off on cost, design choice and power consumption.

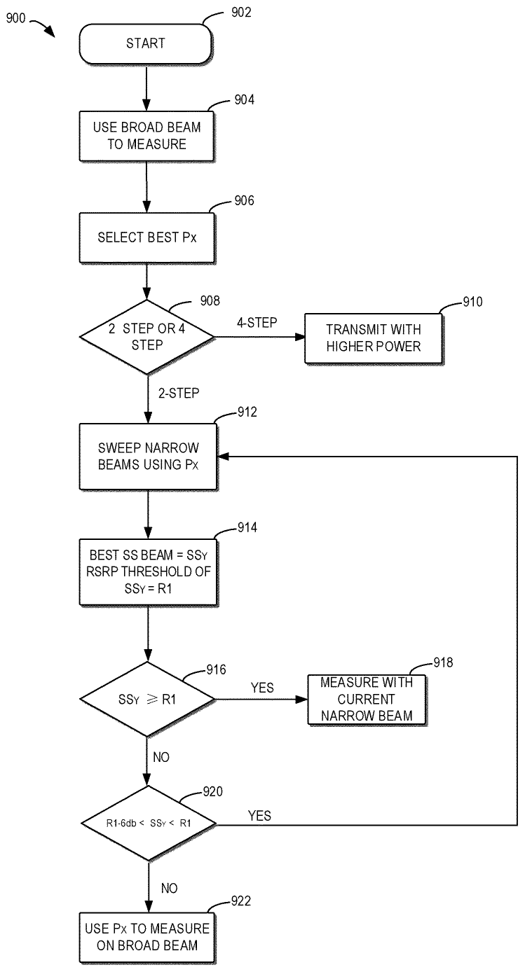

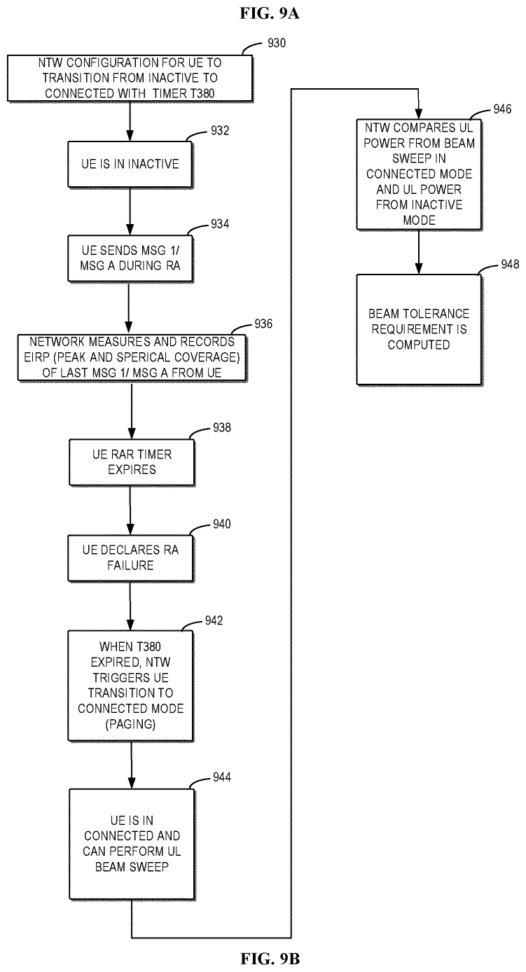

Reference is made to FIG. 9A, which illustrates an example block diagram of process 900 for UE procedure for beam correspondence requirements in accordance with some example embodiments of the present disclosure. At 902, process 900 starts. At 904, UE 110 uses broad beam to measure on each panel. At 906, UE 110 selects the best panel (hereafter referred as Pₓ). At 908, UE 110 uses 2-step RACH or 4-step RACH. If UE 110 uses 2-step RACH, it continues to 912. If UE 110 uses 4-step RACH, it continues to 910. At 910, UE 110 transmits with a higher power. At 912, UE 110 sweep narrow beams using Pₓ. At 914, UE 110 determines best SS beam=SSYRSRP THRESHOLD of SSY=R1. At 916, UE 110 determines if SSY is equal to or larger than R1. If SSY is equal to or larger than R1, the proccess continues to 918. At 918, UE110 measures with current narrow beam. If SSY is less than R1, the proccess continues to 920. At 920, UE 110 determines if condition “R1-6 db is less than SSY, where SSY is less than R1” is true. If it is true, the process continues to 912. If it is false, the process continues to 922. At 922, UE 110 uses Pₓ to measure on broad beam.

In some example embodiments, an apparatus capable of performing the method 300 (for example, the terminal device 110) may comprise means for performing the respective steps of the method 300. The means may be implemented in any suitable form. For example, the means may be implemented in a circuitry or software module.

In some example embodiments, the apparatus comprises: means for obtaining, at a terminal device, a first configuration and a second configuration for a random access response, RAR, timer during a random access, RA, procedure; means for applying, at the terminal device, the first configuration for the RAR timer for at least one RAR window during the RA procedure; and means for applying, at the terminal device, the second configuration for the RAR timer for at least one other RAR window during the RA procedure, wherein the at least one other RAR window comprises at least a last RAR window of the RA procedure for a given synchronization signal block, SSB.

In some example embodiments, each configuration comprises a parameter indicating a time length of a RAR window, wherein the second configuration indicates a longer time length for the RAR window than the first configuration.

In some example embodiments, the second configuration is applicable only to the last RAR window of the RA procedure.

In some example embodiments, the apparatus further comprises: means for holding, within the last RAR window, a beam pattern of the terminal device in a direction, wherein transmission power associated with the last RAR window is determined based on at least one power ramping step during the RA procedure.

In some example embodiments, the apparatus further comprises: means for maintaining, within the last RAR window, the beam pattern for at least one subsequent test.

In some example embodiments, the apparatus further comprises: means for determining a first SSB parameter indicating a SSB periodicity; and means for applying the indicated SSB periodicity for performing alignment between a receive beam and a transmit beam.

In some example embodiments, the apparatus further comprises: means for determining a second SSB parameter indicating a number of SSBs per a synchronization signal burst, SS-burst; and means for applying the indicated number of SSBs for performing the alignment between the receive beam and the transmit beam.

In some example embodiments, the indicated number of SSBs per SS-burst is more than two, each SSB being associated with a dedicated index.

In some example embodiments, the apparatus further comprises: means for determining, based on the number of SSBs, a number of beams to be tested.

In some example embodiments, the apparatus further comprises: means for receiving, from a network device, at least one of the following: a first indication of beam correspondence requirements for a 2-step RA procedure or a second indication of beam correspondence requirements for a 4-step RA procedure, wherein the beam correspondence requirements for the 2-step RA procedure are different than for the 4-step RA procedure; means for determining whether a to be applied RA procedure is a 2 step RA procedure or a 4-step RA procedure; and means for applying the corresponding beam correspondence requirements for the RA procedure.

In some example embodiments, the beam correspondence requirements for the 2-step RA procedure are more stringent than for the 4-step RA procedure, and wherein the requirements differ in at least one of the following: time required by the terminal device to measure downlink beam and to infer uplink beam, or uplink transmit power required for transmitting at least one RA message during the RA procedure.

In some example embodiments, means for obtaining the second configuration comprises means for receiving, from a network device, a RRC messages comprising the second configuration.

In some example embodiments, the terminal device is in an idle mode or an inactive mode.

In some example embodiments, the RA procedure is carried out for the purpose of beam correspondence test, the beam correspondence test comprising alignment between a receive beam and a transmit beam.

In some example embodiments, the apparatus further comprises: means for measuring, within the last RAR window, one or more of: an effective isotropic radiated power, EIRP, and spherical coverage for UE conformance tests, an equivalent isotropic sensitivity, EIS, for downlink, DL, and an EIRP for uplink, UL.

In some example embodiments, the apparatus further comprises: means for transmitting a last preamble before the last RAR window; means for transitioning from idle or inactive mode to a connected mode; and means for performing an uplink beam sweep.

In some example embodiments, an apparatus capable of performing the method 400 (for example, the network device 120) may comprise means for performing the respective steps of the method 400. The means may be implemented in any suitable form. For example, the means may be implemented in a circuitry or software module.

In some example embodiments, the apparatus comprises: means for determining, at a network device, a first configuration and a second configuration for a random access response, RAR, timer during a random access, RA, procedure, the first configuration being applicable for at least one RAR window during the RA procedure and the second configuration being applicable for at least one other RAR window during the RA procedure, the at least one other RAR window comprising at least a last RAR window of the RA procedure for a given synchronization signal block, SSB; and means for transmitting the first configuration and the second configuration to a terminal device.

In some example embodiments, each configuration comprises a parameter indicating a time length of a RAR window, wherein the second configuration indicates a longer time length for the RAR window than the first configuration.

In some example embodiments, the second configuration is applicable only to the last RAR window of the RA procedure.

In some example embodiments, within the last RAR window, a beam pattern at the terminal device is hold in a direction, and wherein transmission power associated with the last RAR window is based on at least one power ramping step during the RA procedure.

In some example embodiments, the apparatus further comprises: means for determining a first SSB parameter indicating a SSB periodicity for the terminal device to perform alignment between a receive beam and a transmit beam; and means for transmitting the first SSB parameter to the terminal device.

In some example embodiments, the apparatus further comprises: means for determining a second SSB parameter indicating a number of SSBs per a synchronization signal burst, SS-burst for the terminal device to perform the alignment between the receive beam and the transmit beam; and means for transmitting the second SSB parameter to the terminal device.

In some example embodiments, the indicated number of SSBs per SS-burst is more than two, each SSB being associated with a dedicated index.

In some example embodiments, the apparatus further comprises: means for transmitting, to the terminal device, at least one of the following: a first indication of beam correspondence requirements for a 2-step RA procedure or a second indication of beam correspondence requirements for a 4-step RA procedure, wherein the beam correspondence requirements for the 2-step RA procedure are different than for the 4-step RA procedure; means for determining whether the to be applied RA procedure is a 2 step RA procedure or a 4-step RA procedure; and means for applying the corresponding beam correspondence requirements for the RA procedure.

In some example embodiments, the beam correspondence requirements for the 2-step RA procedure are more stringent than for the 4-step RA procedure, and wherein the requirements differ in at least one of the following: time required by the terminal device to measure downlink beam and to infer uplink beam, or uplink transmit power required for transmitting at least one RA message during the RA procedure.

In some example embodiments, the means for transmitting the second configuration comprises: means for transmitting, to the terminal device, a radio resource control, RRC, messages comprising the second configuration.

In some example embodiments, the RA procedure is carried out for the purpose of beam correspondence test.

In some example embodiments, the apparatus further comprises: means for performing EIS Spherical Coverage test during last RAR window; means for performing EIRP test during the last transmitted preamble of RA; and means for performing EIRP spherical coverage test during the last transmitted preamble of RA.

In some example embodiments, the apparatus further comprises: means for determining a first uplink power while the terminal device is in idle or in inactive mode, wherein the first uplink power is based on the last preamble sent by the terminal device before last RAR window timer is triggered; means for transitioning the terminal device into connected mode; means for determining a second received uplink power while the terminal device is in connected mode, wherein the second received uplink power is based on highest received power during the terminal device performs beam sweep in the connected mode; and means for performing beam tolerance test by comparing the first uplink power and the second uplink power and the second uplink power.

In some example embodiments, an apparatus capable of performing the method 600 (for example, the terminal device 110) may comprise means for performing the respective steps of the method 600. The means may be implemented in any suitable form. For example, the means may be implemented in a circuitry or software module.

In some example embodiments, the apparatus comprises: means for obtaining, at a terminal device, a first configuration and a second configuration for a random access response, RAR, timer during a random access, RA, procedure; means for applying, at the terminal device, the first configuration for the RAR timer for at least one RAR window during the RA procedure; means for applying, at the terminal device, the second configuration for the RAR timer for at least one other RAR window during the RA procedure, wherein the at least one other RAR window comprises at least a last RAR window of the RA procedure for a given synchronization signal block, SSB; means for receiving, from a network device, at least one of the following: a first indication of beam correspondence requirements for a 2-step RA procedure or a second indication of beam correspondence requirements for a 4-step RA procedure, wherein the beam correspondence requirements for the 2-step RA procedure are different than for the 4-step RA procedure; means for determining whether a to be applied RA procedure is a 2 step RA procedure or a 4-step RA procedure; and means for applying the corresponding beam correspondence requirements for the RA procedure.

In some example embodiments, the beam correspondence requirements for the 2-step RA procedure are more stringent than for the 4-step RA procedure, and wherein the requirements differ in at least one of the following: time required by the terminal device to measure downlink beam and to infer uplink beam, or uplink transmit power required for transmitting at least one RA message during the RA procedure.

FIG. 9B illustrates an example block diagram of process for UE procedure for beam tolerance in accordance with some example embodiments of the present disclosure.

At 930, network (NTW) configuration for UE to transition from idle/inactive to connected with timer 380 (T380). At 932, UE is inactive. At 934, UE sends MSG1 or MSG A during RA.

At 936, network measures and records EIRP (peak and spherical coverage of last MSG 1 or MSG A) from UE. At 938, UE RAR timer expires. At 940, UE declares RA failure. At 942, when T380 expired, network triggers UE transition to connected mode (e.g. paging). At 944, UE is in connected mode and performs UL beam sweep. At 946, network compares UL power from beam sweep in connected mode and UL power from inactive mode. At 948, beam tolerance requirement is computed.

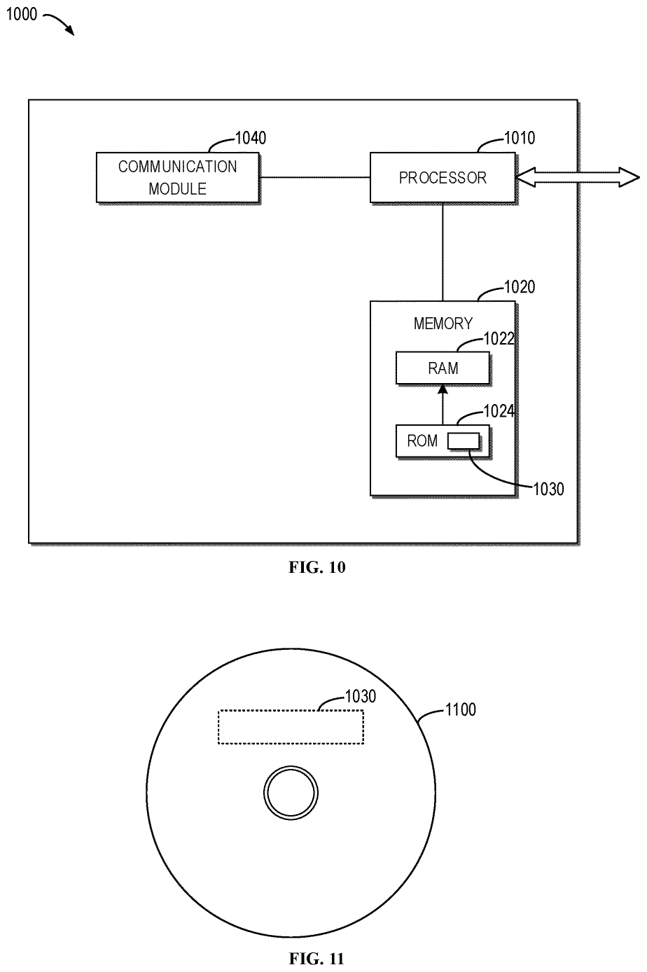

FIG. 10 is a simplified block diagram of a device 1000 that is suitable for implementing embodiments of the present disclosure. The device 1000 may be provided to implement the communication device, for example the terminal device 1010 as shown in FIG. 1A. As shown, the device 1000 includes one or more processors 1010, one or more memories 1040 may couple to the processor 1010, and one or more communication modules 1040 may couple to the processor 1010.

The communication module 1040 is for bidirectional communications. The communication module 1040 has at least one antenna to facilitate communication. The communication interface may represent any interface that is necessary for communication with other network elements, for example the communication interface may be wireless or wireline to other network elements, or software based interface for communication.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a read only memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program so that the device 1000 may perform any process of the disclosure as discussed with reference to FIG. 2, FIG. 3 and FIG. 5 to FIG. 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300, 400 or 600 as described above with reference to FIG. 3, FIG. 4 or FIG. 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-34. (canceled)

35. A terminal device comprising:
at least one processor; and
at least one memory storing instructions that, when executed by the at least one processor, cause the terminal device to:
obtain a first configuration and a second configuration for a random access response (RAR) timer during a random access (RA) procedure, wherein each configuration comprises a parameter indicating a time length of a RAR window, wherein the second configuration indicates a longer time length for the RAR window than the first configuration, wherein the second configuration is applicable only to a last RAR window of the RA procedure;
apply the first configuration for the RAR timer for at least one RAR window during the RA procedure; and
apply the second configuration for the RAR timer for at least one other RAR window during the RA procedure, wherein the at least one other RAR window comprises at least a last RAR window of the RA procedure for a given synchronization signal block (SSB);
hold, within the last RAR window, a beam pattern of the terminal device in a direction, wherein transmission power associated with the last RAR window is determined based on at least one power ramping step during the RA procedure;
receive, from a network device, a first indication of beam correspondence requirements for a 2-step RA procedure, and second indication of beam correspondence requirements for a 4-step RA procedure, wherein the beam correspondence requirements for the 2-step RA procedure are different than for the 4-step RA procedure, wherein the beam correspondence requirements for the 2-step RA procedure are more stringent than for the 4-step RA procedure, and wherein the requirements differ based on the following: time required by the terminal device to measure downlink beam and to infer uplink beam, and uplink transmit power required for transmitting at least one RA message during the RA procedure;
determine whether a to be applied RA procedure is a 2 step RA procedure or a 4-step RA procedure; and
apply the corresponding beam correspondence requirements for the RA procedure.

36. The terminal device of claim 35, wherein the terminal device is further caused to:
maintain, within the last RAR window, the beam pattern for at least one subsequent test.

37. The terminal device of claim 36, wherein the terminal device is further caused to:
determine a first SSB parameter indicating a SSB periodicity; and
apply the indicated SSB periodicity for performing alignment between a receive beam and a transmit beam.

38. The terminal device of claim 37, wherein the terminal device is further caused to:
determine a second SSB parameter indicating a number of SSBs per a synchronization signal burst (SS-burst); and
apply the indicated number of SSBs for performing the alignment between the receive beam and the transmit beam.

39. The terminal device of claim 38, wherein the indicated number of SSBs per SS-burst is more than two, each SSB being associated with a dedicated index.

40. The terminal device of claim 39, wherein the terminal device is further caused to:
determine, based on the number of SSBs, a number of beams to be tested.

41. The terminal device of claim 40, wherein the terminal device is further caused to obtain the second configuration by:
receiving, from a network device, a radio resource control (RRC) messages comprising the second configuration.

42. The terminal device of claim 41, wherein the terminal device is in an idle mode or an inactive mode.

43. The terminal device of claim 42, wherein the RA procedure is carried out for a purpose of beam correspondence test, the beam correspondence test comprising alignment between a receive beam and a transmit beam.

44. The terminal device of claim 43, wherein the terminal device is further caused to:
measure, within the last RAR window, one or more of:
an effective isotropic radiated power, EIRP, and spherical coverage for UE conformance tests;
an equivalent isotropic sensitivity, EIS, for downlink, DL; and
an EIRP for uplink, UL.

45. The terminal device of claim 44, wherein the terminal device is further caused to follow a beam tolerance test comprising:
transmit a last preamble before the last RAR window;
transit from idle or inactive mode to a connected mode; and
perform an uplink beam sweep.

46. A system comprising:
a terminal device;
at least one processor; and
at least one memory storing instructions that, when executed by the at least one processor, cause the terminal device to:
obtain a first configuration and a second configuration for a random access response (RAR) timer during a random access (RA) procedure, wherein each configuration comprises a parameter indicating a time length of a RAR window, wherein the second configuration indicates a longer time length for the RAR window than the first configuration, wherein the second configuration is applicable only to a last RAR window of the RA procedure;
apply the first configuration for the RAR timer for at least one RAR window during the RA procedure; and
apply the second configuration for the RAR timer for at least one other RAR window during the RA procedure, wherein the at least one other RAR window comprises at least a last RAR window of the RA procedure for a given synchronization signal block (SSB);
hold, within the last RAR window, a beam pattern of the terminal device in a direction, wherein transmission power associated with the last RAR window is determined based on at least one power ramping step during the RA procedure;
receive, from a network device, a first indication of beam correspondence requirements for a 2-step RA procedure, and second indication of beam correspondence requirements for a 4-step RA procedure, wherein the beam correspondence requirements for the 2-step RA procedure are different than for the 4-step RA procedure, wherein the beam correspondence requirements for the 2-step RA procedure are more stringent than for the 4-step RA procedure, and wherein the requirements differ based on the following: time required by the terminal device to measure downlink beam and to infer uplink beam, and uplink transmit power required for transmitting at least one RA message during the RA procedure;
determine whether a to be applied RA procedure is a 2 step RA procedure or a 4-step RA procedure; and
apply the corresponding beam correspondence requirements for the RA procedure.

47. The system of claim 46, wherein the terminal device is further caused to:
maintain, within the last RAR window, the beam pattern for at least one subsequent test.

48. The system of claim 47, wherein the terminal device is further caused to:
determine a first SSB parameter indicating a SSB periodicity; and
apply the indicated SSB periodicity for performing alignment between a receive beam and a transmit beam.

49. The system of claim 48, wherein the terminal device is further caused to:
determine a second SSB parameter indicating a number of SSBs per a synchronization signal burst (SS-burst); and
apply the indicated number of SSBs for performing the alignment between the receive beam and the transmit beam.

50. The system of claim 49, wherein the indicated number of SSBs per SS-burst is more than two, each SSB being associated with a dedicated index.

51. The system of claim 50, wherein the terminal device is further caused to:
determine, based on the number of SSBs, a number of beams to be tested.

52. The system of claim 51, wherein the terminal device is further caused to obtain the second configuration by:
receiving, from a network device, a radio resource control (RRC) messages comprising the second configuration.

53. The system of claim 52, wherein the terminal device is in an idle mode or an inactive mode, and wherein the terminal device is further caused to follow a beam tolerance test comprising:
transmit a last preamble before the last RAR window;
transit from the idle or the inactive mode to a connected mode; and
perform an uplink beam sweep.

54. The system of claim 53, wherein the RA procedure is carried out for a purpose of beam correspondence test, the beam correspondence test comprising alignment between a receive beam and a transmit beam, and wherein the terminal device is further caused to:
measure, within the last RAR window, one or more of:
an effective isotropic radiated power, EIRP, and spherical coverage for UE conformance tests;
an equivalent isotropic sensitivity, EIS, for downlink, DL; and
an EIRP for uplink, UL.
